(19) United States
(12) Patent Application Publication
(10) Pub. No.: US 2022/0201745 A1
(43) Pub. Date: Jun. 23, 2022

(54) METHOD AND DEVICE FOR INITIAL SIGNAL PROCESSING, AND STORAGE MEDIUM

(71) Applicant: SPREADTRUM COMMUNICATIONS (SHANGHAI) CO., LTD., Shanghai (CN)

(72) Inventors: Huayu ZHOU, Shanghai (CN); Xingya SHEN, Shanghai (CN); Zhengang PAN, Shanghai (CN)

(21) Appl. No.: 17/422,105

(22) PCT Filed: Jan. 8, 2020
(86) PCT No.: PCT/CN2020/070937

§ 371 Date: Mar. 11, 2022

(30) Foreign Application Priority Data
Jan. 11, 2019 (CN) 201910028714.6

(51) Int. Cl. H04W 74/08; H04W 16/14; H04W 74/00

(52) U.S. Cl. CPC H04W 74/0808; H04W 74/006; H04W 16/14

(57) ABSTRACT

The present disclosure relates to a method and a device for initial signal processing. The method comprises: determining, by a UE after detecting an initial signal in an unlicensed spectrum, one or more types of PDCCH candidates for which listening is required. By the present disclosure, one or more types of PDCCHs for which listening is required can be determined and a COT structure can be obtained based on the PDCCHs.

This application claims priority to the Chinese Application No. 201910028714.6 of the same title, filed on Jan. 11, 2019, which is incorporated by reference herein.

### TECHNICAL FIELD

The present disclosure relates to a communication technology field, particularly to a method and a device for initial signal processing and a storage medium.

### BACKGROUND

In an unlicensed spectrum of 5G New Radio (NR), a base station acquires a Transmission Opportunity (TXOP) by transmitting Listen Before Talk (LBT). The base station informs a User Equipment (UE) that the base station has acquired the TXOP by transmitting an initial signal to the UE. After detecting the initial signal successfully, the UE knows that the base station acquires the TXOP and then starts a series of actions, such as listening a Physical Downlink Control Channel (PDCCH), etc. The initial signal is also called a Preamble signal or a Wake-Up Signal (WUS). The UE detects the initial signal during an active time by default and starts to listen to the PDCCH only when the initial signal is detected. In such a way, the initial signal also has a function of power saving and thus can also be called a Power Saving Signal.

The UE is required to listen to one or more types of PDCCHs to obtain a Channel Occupancy Time (COT) structure after detecting the initial signal successfully. However, how the UE listens to the one or more types PDCCHs to obtain the COT structure after detecting the initial signal successfully needs to be resolved urgently.

### SUMMARY

According to a first aspect of the present disclosure, there is provided a method for initial signal processing, the method comprising: determining, by the UE after detecting the initial signal on the unlicensed spectrum, one or more types of PDCCH candidates for which listening is required.

According to a second aspect of the present disclosure, there is provided a method for initial signal processing, the method comprising: listening to, by the UE after detecting the initial signal on the unlicensed spectrum, one or more types of PDCCH candidates according to the configured listening opportunity.

According to a third aspect of the present disclosure, there is provided a device for initial signal processing, the device comprising: a listening unit configured to determine one or more types of PDCCH candidates for which listening is required after detecting the initial signal on the unlicensed spectrum.

According to the following detailed description of exemplary embodiments with reference to the accompanying drawings, other features and aspects of the present disclosure will become clear.

### BRIEF DESCRIPTION OF THE DRAWINGS

The attached drawings are included in, and constitute a part of, the specification, illustrate embodiments, features and aspects of the present disclosure together with the description thereof to explain principle of the present disclosure.

FIG. 1 is a flowchart illustrating an initial signal processing method according to an embodiment of the present disclosure.

FIG. 2 is a flowchart illustrating an initial signal processing method according to an embodiment of the present disclosure.

FIG. 3 is a flowchart illustrating an initial signal processing method according to an embodiment of the present disclosure;

FIG. 4 is a flowchart illustrating an initial signal processing method according to an embodiment of the present disclosure;

FIG. 5 is a block diagram illustrating an initial signal processing device according to an embodiment of the present disclosure;

FIG. 6 is a block diagram illustrating an initial signal processing device according to an embodiment of the present disclosure; and

FIG. 7 shows a block diagram illustrating an initial signal processing device according to an embodiment of the present disclosure.

### DETAILED DESCRIPTION

Hereinafter, various exemplary embodiments, features and aspects of the present disclosure will be described in detail below with reference to the accompanying drawings. Identical reference signs in the accompanying drawings indicate functionally identical or similar elements. Although various aspects of the embodiments are illustrated in the accompanying drawings, it is not necessary to draw the drawings to scale unless otherwise indicated.

The term “exemplary” is used herein to mean “used as an example, embodiment, or illustration”. Any embodiment illustrated herein as “exemplary” need not be construed as superior or better than other embodiments.

In addition, numerous specific details are given in the specific embodiments below to better illustrate the present disclosure. It should be understood by those skilled in the art that the present disclosure can be implemented equally well without certain specific details. In some embodiments, methods, means, elements and circuits that are known to those skilled in the art are not described in detail so as to highlight the main point of the present disclosure.

The present disclosure proposes a method and a device for initial signal processing and a storage medium that can determine one or more types of PDCCHs for which listening is required and obtain the COT structure based on the PDCCHs.

The present disclosure can determine, by the UE after detecting the initial signal on the unlicensed spectrum, the one or more types of PDCCH candidates for which listening is required. The present disclosure can determine one or more types of PDCCHs for which listening is required and obtain the COT structure based on the PDCCHs.

The relevant contents of the 5G technology involved in the present disclosure are described as follows.

I. Synchronization Signal Block:

In the 5G system, synchronization signals and broadcast channels are transmitted as synchronization signal blocks and beam sweeping are introduced. Primary Synchronization Signal (PSS), Secondary Synchronization Signal (SSS) and Physical Broadcast Channel (PBCH) are in the SS/PBCH blocks. Each synchronization signal block can be considered as a resource for one beam (analog domain) in the beam sweeping process. A plurality of synchronization signal blocks form a synchronization signal burst (SS-burst), which can be considered as a relatively concentrated resource containing a plurality of beams. A plurality of SS-bursts form a synchronization signal burst-set (SS-burst-set). The synchronization signal blocks are repeatedly transmitted on different beams, which is a process of beam sweeping. Through training of the beam sweeping, the UE can sense on which beam the strongest signal is received. For example, time domain positions of L synchronization signal blocks within a 5 ms window are fixed. Indices (from 0 to L−1, where L is an integer greater than 1) of L synchronization signal blocks are arranged consecutively in the time domain positions. Thus, the emission timing of one synchronization signal block within the 5 ms window is fixed and the index is also fixed.

II. Discovery Reference Signal (DRS) in Licensed Assisted Access (LAA):

A DRS defined in LTE Release 12 is for tracking and measuring synchronization time-frequency of a Secondary Cell (SCell) by the UE, which can be called a “discovery” function of the SCell. The advantage of using DRS includes that DRS is a long-cycle signal, which has less interference to the entire network. The DRS is composed of PSS/SSS/CRS, where CRS is a Cell-specific Reference Signal (CRS). DRS duration is one to five consecutive sub-frames for a FDD system and is two to five consecutive sub-frames for a TDD system. The emission timing of the DRS is defined by the Discovery Measurement Timing Configuration (DMTC). The UE assumes that the DRS occurs once in each DMTC cycle.

In LAA of LTE, the DRS can be used exactly for the discovery function of SCells on the unlicensed spectrum. Due to its long-cycle, the DRS is useful to reduce the interference to the LAA system and a heterogeneous system (e.g., Wifi system) sharing unlicensed spectrum. The duration of the LAA DRS is twelve orthogonal frequency division multiplexing (OFDM) symbols within a non-empty sub-frame to further reduce interference to the LAA system and the heterogeneous system. The LAA DRS also includes PSS/SSS/CRS.

The LAA DRS will appear in the following two cases:

Case I: The UE can assume that the LAA DRS probably appear in any sub-frame in the DMTC and assume that the LAA DRS appears on a first sub-frame that contains a PSS, a SSS and a CRS in the DMTC. In other words, the UE assumes that the LBT is performed by the base station within the DMTC and if a channel idle is listened to, the base station transmits a DRS on a non-empty sub-frame.

Case II: When the LAA DRS is transmitted together with PDSCH/PDCCH/EPDCCH, the LAA DRS probably appears only in sub-frame 0 and sub-frame 5. That is, if the DMTC contains the sub-frame 0 or 5 and the UE needs to detect PDCCH/EPDCCH or receive PDSCH on the sub-frame 0 or 5, the UE assumes that DRS appears only on the sub-frame 0 or 5.

III. Residual Minimum System Information (RMSI) in 5G:

The RMSI in 5G is equivalent to SIB1 in LTE, including main system information except MIB. The RMSI is carried in the PDSCH which is scheduled through the PDCCH. The PDSCH that carries the RMSI is generally referred to as the RMSI PDSCH and the PDCCH that schedules the RMSI PDSCH is generally referred to as the RMSI PDCCH.

Generally, a search space set contains properties of the PDCCH, such as listening timing, search space type, etc. The search space set is generally bound to a control resource set (CORESET) and the CORESET contains properties of the PDCCH, such as frequency domain resources and duration.

The search space set where the RMSI PDCCH is located is generally referred to as the Type0-PDCCH search space set. Generally, it is configured by MIB or by RRC in cases such as switching. Type0-PDCCH search space set is referred to as search space 0 (or search space set 0) and the bound CORESET is referred to as CORESET 0; in addition to the search space set of the RMSI PDCCH, other public search spaces or public search space sets, such as search space set of the OSI PDCCH (Type0A-PDCCH search space set), the search space set of RAR PDCCH (Type1-PDCCH search space set), and the search space set of paging PDCCH (Type2-PDCCH search space set), etc., can be equivalent to the search space set 0 by default. Generally, both the above common search space or common search space set can be reconfigured.

IV. LBT of the Synchronization Signal Block:

The synchronization signal block is required to be defined on the unlicensed spectrum of NR so that the UE can detect NR unlicensed spectrum cells in a cell search. The synchronization signal block may be contained in the DRS which acts as a whole containing the synchronization signal block or the synchronization signal block exists independently without defining DRS.

The base station needs to perform LBT before transmitting the DRS or the synchronization signal block on the unlicensed spectrum of NR. The base station transmits DRS or the synchronization signal block only after listening to the signal idle, otherwise the base station performs LBT after a period of time. The DRS or the synchronization signal block is transmitted within a transmitting window, and the transmitting window can be agreed by the base station with the UE or can be configured by RRC signaling via DMTC or Synchronization Measurement Timing Configuration (SMTC).

The DRS or the synchronization signal block needs to be panned backward for a period of time since the LBT is required to be performed. In order to support the characteristic of backward panning of the DRS or the synchronization signal block on the unlicensed spectrum, the DRS or the synchronization signal block needs to have a plurality of predefined time domain positions.

V. LBT of RMSI:

The base station needs to perform LBT before transmitting the RMSI on the unlicensed spectrum of NR. The base station transmits RMSI only after listening to the signal idle, otherwise the base station performs LBT after a period of time. The RMSI is transmitted within a transmitting window, and the transmitting window can be agreed by the base station with the UE or can be configured by MIB or Radio Resource Control (RRC) signaling.

The RMSI needs to be panned backward for a period of time since the LBT is required to be performed. In order to support the characteristic of backward panning of RMSI on the unlicensed spectrum, the RMSI needs to have a plurality of predefined time domain positions.

In summary, for the initial signal, on the unlicensed spectrum of NR, the base station will transmit the initial signal after acquiring the TXOP through the LBT to tell the UE that the base station has acquired the TXOP. Usually, the UE is required to listen to one or more types of PDCCHs to obtain the COT structure after detecting the initial signal successfully. The one or more types of PDCCHs may be configured by search space set. The COT structure includes a period of time during which the base station occupies the channel (e.g., a few milliseconds or a few time slots), a format of the time slots during the period of time (e.g., configurations of uplink, downlink, and flexible symbol), and sub-channel or sub-band available during the period of time, where the sub-band is a basic unit of LTB (e.g., 20 MHz bandwidth), etc.

With the following embodiments, on the unlicensed spectrum of NR, the UE can determine, after detecting the initial signal successfully, one or more types of PDCCHs to be listened to so as to obtain the COT structure based on the PDCCH.

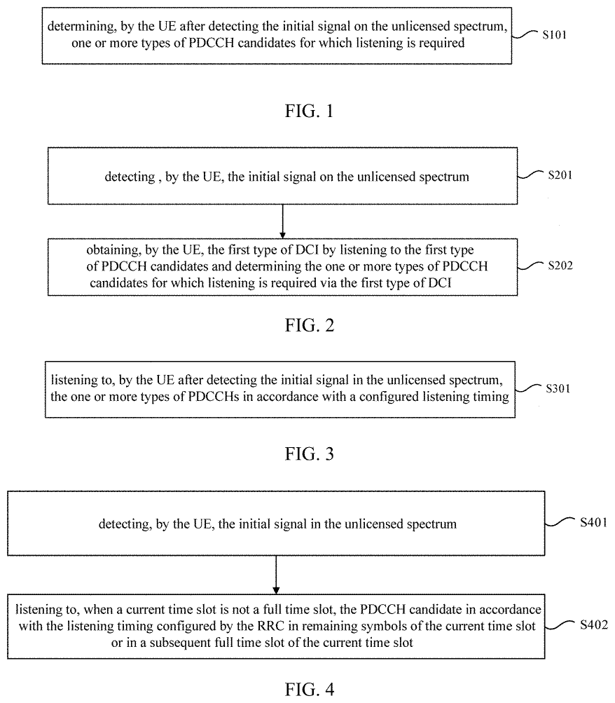

FIG. 1 is a schematic flowchart illustrating a method for initial signal processing according to an embodiment of the present disclosure. As shown in FIG. 1, the process comprises:

S101: determining, by the UE after detecting the initial signal on the unlicensed spectrum, one or more PDCCH candidates for which listening is required.

In a possible implementation, the types of the one or more types of PDCCH candidates include a first type PDCCH and scheduling PDCCH.

In a possible implementation, the method further comprises: indicating, by the UE, the COT structure via the first type of PDCCH candidates. The COT structure is a structure adopted by the base station after acquiring the channel, comprising: a time domain which may include a frame structure, a time slot structure and/or types of symbol (including uplink, downlink, and flexible, etc.) and a frequency domain structure which may include a case of an occupied sub-band and/or occupied PRB, etc.

In an example, with respect to the PDCCH frequency domain positions, the UE determines the first type of PDCCH candidates for which listening is required after detecting the initial signal successfully. Further, the UE acquires the first type of downlink control information (DCI) by listening to the first type of PDCCH candidates and the UE determines the PDCCH candidates for which listening is required via the first type of DCI. Alternatively, the UE directly determines that the PDCCH candidates for which listening is required include the first type of PDCCH candidates after detecting the initial signal successfully.

FIG. 2 is a schematic flowchart illustrating a method for initial signal processing according to an embodiment of the present disclosure. As shown in FIG. 2, the process comprises:

S201: detecting the initial signal by the UE on the unlicensed spectrum.

S202: obtaining the first type of DCI by the UE through listening to the first type of PDCCH candidates; and determining the one or more types of PDCCH candidates for which listening is required by the UE via the first type of DCI.

In a possible implementation, in addition to the above S101 where the one or more types of PDCCH candidates for which listening is required are determined based on the initial signal directly, to put it simply, an implementation is further included as follows: finding the first type of DCI based on the initial signal, and then determining the candidate PDCCHs based on the first type of DCI, such as determining CORESET based on the first type of DCI; determining the search space set based on the first type of DCI; and determining BWP based on the first type of DCI. Another implementation is a method in conjunction with the above S101, for example, finding the first type of DCI which indicates the sub-band based on the initial signal, and then determining the candidate PDCCHs based on the first type of DCI after determining the sub-band based on the first type of DCI.

Specifically, the UE determines the PDCCH candidates for which listening is required via the first type of DCI, comprising: determining the first type of DCI after detecting the initial signal; and determining the PDCCH candidates for which listening is required after determining the CORESETs of all the candidates based on the first type of DCI, wherein the CORESET may define basic time-frequency domain resources.

Specifically, the UE determines the PDCCH candidates for which listening is required via the first type of DCI, comprising: determining the first type of DCI after detecting the initial signal; and determining the PDCCH candidates for which listening is required after determining the search space set of all the candidates based on the first type of DCI.

Specifically, the UE determines the PDCCH candidates for which listening is required via the first type of DCI, comprising: determining the first type of DCI after detecting the initial signal; and determining the PDCCH candidates for which listening is required after determining the Bandwidth Parts (BWPs) of all the candidates based on the first type of DCI.

In a possible implementation, after detecting the initial signal, it is directly determined that the PDCCH candidates for which listening is required include the first type of PDCCH candidates.

In a possible implementation, the method further comprises: determining, after detecting the initial signal in one or more sub-bands, that the frequency domain resources of the PDCCH candidates for which listening is required are in the sub-bands.

In an example, after detecting the initial signal successfully in a certain sub-band, the UE determines that the frequency domain resources of the PDCCHs for which listening is required are in that sub-band. This method of determining the PDCCH for which listening is required by the frequency domain resource relationship is suitable for Group Common-PDCCH (GC-PDCCH) which indicates the PDCCH for which detection is required for a group of UEs, or the DCI content corresponding to this PDCCH is common to a group of UEs since the common frequency domain resources can be used by the group of UEs.

In a possible implementation, the determining, after detecting the initial signal in one or more sub-bands, that the frequency domain resources of PDCCH candidates for which listening is required are in the sub-bands further comprises: determining, in the process of determining all the candidate PDCCHs after detecting the initial signal by the UE in the sub-bands, the PDCCH candidates are required to be listened if the frequency domain resources of the PDCCH candidates are contained in the sub-bands.

In an example, the UE inspects all possible PDCCH candidates after detecting the initial signal successfully in a certain sub-band; if the frequency domain resources of a certain PDCCH candidate are contained in that sub-band, the UE determines that the PDCCH candidate needs to be detected.

In a possible implementation, the determining, after detecting the initial signal in one or more sub-bands, the frequency domain resources of PDCCHs for which listening is required further comprises: determining the PDCCH candidates within the CORESET for which listening is required if the CORESET is contained in the sub-band in the process of determining the CORESET of all the candidates after detecting the initial signal by the UE in the sub-band.

In an example, all possible CORESETs are inspected after detecting the initial signal successfully by the UE in a certain sub-band. If a certain CORESET is contained in that sub-band, the UE determines that the PDCCH within that CORESET needs to be detected. The “all possible CORESETs” can be all CORESETs in the currently active BWPs or all CORESETs within all configured BWPs. The CORESET is associated to the search space set (mainly configuring a timing of the PDCCH that the UE is required to listen to or a time domain position of the PDCCH that the UE is required to listen to), i.e., a given search space set must be associated to a CORESET. Different search space sets can be associated to the same CORESET, or in other words, one CORESET can “contain” or be associated with a plurality of search space sets. Thus the above scheme is more generally described as follows: the UE inspects all search space sets after successfully detecting the initial signal in a sub-band, if a certain CORESET associated with a certain search space set is contained in that sub-band, the UE considers that the PDCCHs in that search space set need to be detected.

In a possible implementation, determining, after detecting the initial signal in the one or more sub-bands, that the frequency domain resources of the PDCCHs for which listening is required are in the sub-bands further comprises: determining by the UE, in a process of determining search space sets of all the candidates after detecting the initial signal by the UE in the sub-bands, it is required to listen to the search space set if the CORESET associated with the search space set is contained in the sub-bands.

In a possible implementation, determining, after detecting the initial signal in the one or more sub-bands, that the frequency domain resources of the PDCCHs for which listening is required are in the sub-bands further comprises: determining BWPs of all candidates after detecting the initial signal by the UE in the sub-bands; and if the BWP is contained in the sub-bands, the UE determines that the BWP is activated.

In a possible implementation, the method further comprises: determining by the UE, after the UE determines that the BWP obtained from the inspection is activated, that all PDCCHs configured in the search space set within the BWP are required to be detected.

In an example, the UE inspects all configured BWPs after detecting the initial signal in a certain sub-band successfully. If a certain BWP is contained in the sub-band, the UE considers that the BWP is activated and the UE considers that all PDCCHs configured in the search space set within that BWP are required to be detected. In general, when a BWP is activated, all the PDCCHs configured in the search space set within that BWP are required to be detected.

In a possible implementation, after detecting the initial signal in one or more sub-bands, determine that a PRB index of the PDSCH to be scheduled is an index of the PRBs arranged in an order within the one or more sub-bands. The above possible implementations are applicable in a case where the initial signal is detected successfully within one sub-band in the above example and are still applicable when the initial signal is detected successfully within a plurality of sub-bands.

In a possible implementation, the method further comprises: determining, after detecting one or more initial signals by the UE, PDCCH candidates associated with the initial signals as PDCCH candidates for which listening is required. Herein, when there are a plurality of initial signals, the UE only listens to the PDCCH candidate associated with each of the plurality of initial signals in the plurality of initial signals. This way of determining the PDCCH for which listening is required by means of association relationship is suitable for a UE specific PDCCH, i.e., the DCI content corresponding to the PDCCH is specific to a UE only.

In a possible implementation, the determining, after detecting one or more initial signals by the UE, that PDCCH candidates associated with the initial signals as PDCCH candidates for which listening is required further comprises: listening to, after detecting the initial signal by the UE, the PDCCH candidates associated with the initial signal.

In an example, the UE determines PDCCH candidates associated with the initial signal upon a successful detection of an initial signal, where the UE is only required to listen to the associated PDCCH candidates.

In a possible implementation, the determining, after detecting one or more initial signals by the UE, that PDCCH candidates associated with the initial signal are required to be listened to further comprises: determining, after detecting the initial signal successfully by the UE, a CORESET ID associated with the initial signal, where the UE is only required to listen to the PDCCH candidates within the associated CORESET.

In an example, a more general description of determining, after detecting the initial signal successfully by the UE, a CORESET ID associated with the initial signal, where the UE is only required to listen to the PDCCH candidate within the associated CORESET is as follows: determining, upon a successful detection of an initial signal by the UE, a CORESET ID associated with the initial signal, where the UE is only required to listen to the PDCCH candidates within the space search set associated with the associated CORESET.

In a possible implementation, the determining, after detecting one or more initial signals by the UE, PDCCH candidates associated with the initial signal are required to be listened to further comprises: determining, after detecting the initial signal by the UE, the CORESET ID associated with the initial signal, where the UE is only required to listen to the PDCCH candidates within the search space set associated with the associated CORESET.

In a possible implementation, the determining, after detecting one or more initial signals by the UE, PDCCH candidates associated with the initial signal are required to be listened to further comprises: determining, after detecting the initial signal by the UE, the search space set ID associated with the initial signal, where the UE is only required to listen to the PDCCH candidates within the associated search space set.

In an example, the UE determines, upon a successful detection of an initial signal, a search space set ID associated with the initial signal, where the UE is only required to listen to the PDCCH candidates within the associated search space set.

In a possible implementation, the determining, after detecting one or more initial signals by the UE, that PDCCH candidates associated with the initial signal are required to be listened to further comprises: determining, after detecting the initial signals by the UE, a BWP ID associated with the initial signal, where the UE determines that the BWP is activated.

In a possible implementation, the method further comprises that the UE is only required to listen to all PDCCH candidates configured in the search space set within the activated BWP.

In an example, the UE determines the BWP ID associated with the initial signal after detecting the initial signal successfully, the UE then considers that the BWP is activated and the UE is only required to listen to all PDCCH candidates configured in the search space set within the activated BWP.

The above possible implementations are not only applicable to a case where the UE successfully detects one initial signal in the above example but are also applicable to a case where the UE detects a plurality of initial signals successfully.

FIG. 3 is a flowchart illustrating a method for initial signal processing according to an embodiment of the present disclosure. As shown in FIG. 3, the process comprises:

S301: listening to, by the UE after detecting the initial signal in the unlicensed spectrum, one or more types of PDCCHs in accordance with a configured listening timing.

To be distinguished from the above embodiments, a listening timing is introduced, i.e., listening to one or more types of PDCCHs in accordance with the configured listening timing.

In a possible implementation, the types of the one or more types of PDCCH candidates include a first type PDCCH and scheduling PDCCH.

In a possible implementation, the method further comprises: indicating, by the UE, the COT structure via the first type of PDCCH candidates. The COT structure is a structure adopted by the base station after acquiring the channel, comprising a time domain structure which may include a frame structure, a time slot structure and/or types of symbols (including uplink, downlink, and flexible, etc.) and a frequency domain structure which may include a case of occupied sub-band and/or occupied PRB, etc.

FIG. 4 is a flowchart illustrating a method for initial signal processing according to an embodiment of the present disclosure. As shown in FIG. 4, the process comprises:

S401: detecting, by the UE, the initial signal in the unlicensed spectrum.

S402: listening to, when a current time slot is not a full time slot, the PDCCH candidate in accordance with the listening timing configured by the RRC in remaining symbols of the current time slot or in a subsequent full time slot of the current time slot.

Specifically, the first type of PDCCH candidates is listened to in accordance with the configured listening timing. The listening timing configuration in the present disclosure refers to the PDCCH listening timing configured in the search space set and is specified by parameters in the search space set configuration.

In a possible implementation, the first type of PDCCH candidates is listened to when the listening timing is for the first type of PDCCH candidates.

In a possible implementation, the listening to, by the UE, the first type of PDCCH candidates in accordance with the configured listening timing further comprises at least one combination of the following three implementations:

Mode I: listening to, by the UE after detecting the initial signal, the first type of PDCCH candidates in a default manner in the remaining symbols of the current time slot when the current time slot is not a full time slot.

Mode II: listening to, by the UE after detecting the initial signal, the PDCCH candidates in accordance with the listening timing configured by the RRC in the subsequent full time slot of the current time slot when the current time slot is not a full time slot; and listening to the first type of PDCCH candidates when the listening timing configuration is a listening timing configuration of the first type of PDCCH candidates.

In a possible implementation, the listening to, by the UE, the first type of PDCCH candidates in accordance with the configured listening timing further comprises: listening to by the UE after detecting the initial signal, a configured PDDCH candidate in the remaining symbols of the current time slot according to the time slot configured by the RRC for partial time slots if the current time slot is not a full time slot; and listening to, the first type of PDCCH candidates when the listening timing configuration is a listening timing configuration of the first type of PDCCH candidates

In a possible implementation, the method further comprises: listening to the PDCCH candidates at subsequent full time slots of the current time slot in accordance with the listening timing configured by the RRC; and listening to the first type of PDCCH candidates when the listening timing configuration is a listening timing configuration of the first type of PDCCH candidates.

Mode III: In a possible implementation, the listening to, after detecting the initial signal by the UE, the first type of PDCCH candidates in accordance with the configured listening timing further comprises: not requiring to listen to, if the current time slot is not a full time slot, the first type of PDCCH candidates in the current time slot; listening to the PDCCH candidates in accordance with the listening timing configured by the RRC in the subsequent full time slot of the current time slot; and listening to the first type of PDCCH candidates when the listening timing configuration is a listening timing configuration of the first type of PDCCH candidates.

In an example of listening to the first type of PDCCH candidates:

After detecting the initial signal successfully by the UE, if the current time slot is not a “full time slot”, listening to the first type of PDCCH candidates in accordance with the listening timing configuration configured by the RRC (the search space set configuration of the first type of PDCCH candidates) in the remaining symbols of the current time slot; and listening to the first type of PDCCH candidates in accordance with the listening timing configuration configured by the RRC (the search space set configuration of the first type of PDCCH candidates) in the subsequent full time slots.

After detecting the initial signal successfully by the UE, if the current time slot is not a full time slot, listening to the first type of PDCCH candidates in the remaining symbols of the current time slot in a default manner, for example, the first symbol of every two symbols is a start symbol of the PDCCH listening timing by default; and listening to the first type of PDCCH candidates in accordance with the listening timing configuration configured by the RRC (the search space set configuration of the first type of PDCCH candidates) in the subsequent full time slots.

After detecting the initial signal successfully by the UE, if the current time slot is not a full time slot, listening to the first type of PDCCH candidates in accordance with the listening timing configuration configured by the RRC for partial time slots (the search space set configuration of the first type of PDCCH candidates) in the remaining symbols of the current time slot; and listening to the first type of PDCCH candidates in accordance with the listening timing configuration configured by the RRC (the search space set configuration of the first type of PDCCH candidates) in the subsequent full time slots.

After detecting the initial signal successfully by the UE, if the current time slot is not a full time slot, the UE is not required to listen to the first type of PDCCH candidates in the current time slot; and listening to the first type of PDCCH candidates in accordance with the listening timing configuration configured by the RRC (the search space set configuration of the first type of PDCCH candidates) in the subsequent full time slots.

In a possible implementation, the method further comprises: listening to, by the UE, the scheduling PDCCH candidates in accordance with the configured listening timing.

In a possible implementation, the listening to, by the UE, the scheduling PDCCH candidates in accordance with the configured listening timing further comprises: if the UE fails to detect the first type of PDCCH candidates, listening to, by the UE, the PDCCH candidates in accordance with the listening timing configuration configured by the RRC, listening to the scheduling PDCCH in accordance with the listening timing configuration.

In a possible implementation, the listening to, by the UE, the scheduling PDCCH candidates in accordance with the configured listening timing further comprises: if the UE fails to detect the first type of PDCCH candidates, the UE is not required to listen to the scheduling PDCCH until the first type of PDCCH candidates are detected.

In a possible implementation, the method further comprises: acquiring, by the UE, a starting time slot position corresponding to indication information of the first type of DCI.

In a possible implementation, the acquiring, by the UE, the starting time slot position corresponding to the indication information of the first type of DCI further comprises: taking the current time slot (i.e., the time slot where the first type of PDCCH is detected) as the starting time slot corresponding to the indication information of the first type of DCI. This approach is suitable for the indication information to target the current time slot and the subsequent time slot with the benefit of saving cost.

In a possible implementation, the acquiring, by the UE, the starting time slot position corresponding to the indication information of the first type of DCI further comprises: if an index of the current time slot is n and the current time slot is the kth time slot in the COT structure, taking the index of the starting time slot corresponding to the indication information of the first type of DCI as n-k, where k Herein, k is the index of the current time slot indicated to the UE in the COT structure, n is the index of the current time slot or the time slot where the first type of PDCCH is detected, and the index of the starting time slot in the COT structure as inferred by the UE is n-k. This approach is suitable for a case where the indication information is for the current time slot or the previous some time slot is the starting time slot, with the advantage that the indication information can appear several times, each time for the same starting time slot.

In a possible implementation, the acquiring, by the UE, the starting time slot position corresponding to the indication information of the first type of DCI further comprises: if the index of the current time slot is in a time slot format (SF) cycle (also called indication cycle of the time slot format), taking the starting time slot corresponding to the indication information of the first type of DCI as the first time slot in the time slot format cycle, wherein the time slot format cycle is indicated by RRC signaling. This approach is suitable for a case where the indication information is for a semi-statically configured time slot which is the starting time slot and is suitable for a periodic time slot format.

In an example of listening to the scheduling PDCCH candidates: if the UE fails to detect the first type of PDCCH candidates successfully, the UE listens to the scheduling PDCCH in accordance with the listening timing configuration configured by the RRC; if the UE fails to detect the first type of PDCCH candidates successfully, the UE is not required to listen to the scheduling PDCCH until the first type of PDCCH candidates are detected successfully.

Herein, the indication information of the first type of DCI is defined as the indication information containing COT structure information or Slot Format Indicator (SFI), or both. The indication information of the first type of DCI can indicate “flexible” time slots or symbols, “downlink” time slots or symbols, and “uplink” time slots or symbols. In general, the UE listens to the PDCCH candidates only on the downlink symbols, so the indication information of the first type of DCI is more important.

In a possible implementation, the COT structure information in the indication information of the first type of DCI can cover information indicated in the time slot format. For example, when the information indicated in the time slot format indicates that a symbol is “flexible”, the COT structure information in the indication information of the first type of DCI can be modified it to “downlink”.

The indication information of the first type of DCI includes information about multiple consecutive time slots starting from a time slot, such as the duration of the base station occupying the channel, a format of the time slot throughout the duration, and the like. In general, the UE needs to know the starting time slot position corresponding to the indication information of the first type of DCI in order to derive the information about multiple consecutive time slots.

How the UE acquires the starting time slot position corresponding to the indication information of the first type of DCI comprises the following three methods.

Method 1:

Taking the current time slot (i.e. the time slot where the first type of DCI is detected) as the starting time slot corresponding to the indication information of the first type of DCI.

Method 2:

If the index of the current time slot is n and the current time slot is the kth time slot in the COT structure, taking the index of the starting time slot corresponding to the indication information of the first type of DCI as (n-k).

Method 3:

If the index of the current time slot is in the mth time slot format cycle (time slot format cycle is indicated by RRC signaling), taking the starting time slot corresponding to the indication information of the first type of DCI as the first time slot in the mth time slot format cycle.

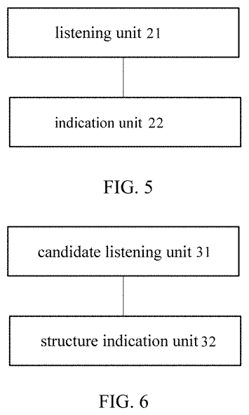

FIG. 5 is a block diagram illustrating an initial signal processing device according to an embodiment of the present disclosure. As shown in FIG. 5, the device comprises: a listening unit 21 configured to determine one or more types of PDCCH candidates for which listening is required after detecting the initial signal in the unlicensed spectrum; and an indication unit 22 configured to indicate the COT structure via first type of PDCCH candidates. This initial signal processing device may be specifically the UE or may be located on the UE side.

In a possible implementation, the types of the one or more types of PDCCH candidates include a first type PDCCH and scheduling PDCCH.

In a possible implementation, the listening unit further comprises: a first acquiring subunit configured to acquire first type of DCI by listening to the first type of PDCCH candidates; and a first listening subunit configured to determine the PDCCH candidates for which listening is required via the first type of DCI.

In a possible implementation, the first listening subunit is further configured to determine the first type of DCI after detecting the initial signal and determine the PDCCH candidates for which listening is required after determining a CORESET of all candidates in accordance with the first type of DCI.

In a possible implementation, the first listening subunit is further configured to determine the first type of DCI after detecting the initial signal and determine the PDCCH candidates for which listening is required after determining search space sets of all candidates in accordance with the first type of DCI.

In a possible implementation, the first listening subunit is further configured to determine the first type of DCI after detecting the initial signal and determine the PDCCH candidates for which listening is required after determining BWPs of all candidates in accordance with the first type of DCI.

In a possible implementation, determining after detecting the initial signal that the PDCCH candidates for which listening is required comprise the first type of PDCCH candidates.

In a possible implementation, the listening unit further comprises: a second listening subunit configured to determine that the frequency domain resources of the PDCCH candidates for which listening is required are in sub-bands after detecting the initial signal in one or more sub-bands.

In a possible implementation, the second listening subunit is further configured to determine that listening to the PDCCH candidates is required if the frequency domain resources of the PDCCH candidates are contained in the sub-bands in the process of determining all candidate PDCCHs after detecting the initial signal in the sub-bands.

In a possible implementation, the second listening subunit is further configured to determine that listening to the PDCCH candidates within the CORESET is required if the CORESET is contained in the sub-bands in the process of determining the CORESETs of all candidates after detecting the initial signal in the sub-bands.

In a possible implementation, the second listening subunit is further configured to determine that listening to the search space set is required if the CORESET associated with the search space set is contained in the sub-bands in the process of determining the search space sets of all candidates after detecting the initial signal in the sub-bands.

In a possible implementation, the second listening subunit is further configured to determine the BWPs of all candidates after detecting the initial signal in the sub-bands and determine that the BWP is activated if the BWP is contained in the sub-bands.

In a possible implementation, the second listening subunit is further configured to determine that all PDCCHs configured in the search space set within the BWP are required to be detected after determining that the BWP obtained from the inspection is activated.

In a possible implementation, the listening unit further comprises a third listening subunit configured to, after one or more initial signals are detected, determine that PDCCH candidates associated with the initial signals as PDCCH candidates for which listening is required, wherein the PDCCH candidates associated with each of the plurality of initial signals are listened to when there are a plurality of initial signals.

In a possible implementation, the third listening subunit is further configured to listen to the PDCCH candidate associated with the initial signal after detecting the initial signal.

In a possible implementation, the third listening subunit is further configured to, after detecting the initial signal, determine the CORESET ID associated with the initial signal and only listen to the PDCCH candidates within the associated CORESET.

In a possible implementation, the third listening subunit is further configured to, after detecting the initial signal, determine the CORESET ID associated with the initial signal and only listen to the PDCCH candidates within the search space set associated with the associated CORESET.

In a possible implementation, the third listening subunit is further configured to, after detecting the initial signal, determine the search space set ID associated with the initial signal and only listen to the PDCCH candidates within the associated search space set.

In a possible implementation, the third listening subunit is further configured to, after detecting the initial signal, determine the BWP ID associated with the initial signal, wherein the UE determines that the BWP is activated.

In a possible implementation, the third listening subunit is further configured to only listen to all PDCCH candidates configured in the search space set within the activated BWP.

FIG. 6 is a block diagram illustrating an initial signal processing device according to an embodiment of the present disclosure. As shown in FIG. 6, the device comprises: a candidate listening unit 31 configured to listen to one or more types of PDCCH candidates in accordance with the configured listening timing after detecting the initial signal in the unlicensed spectrum; and a structure indication unit 32 configured to indicate the COT structure via first type of PDCCH candidates. This initial signal processing device may be specifically a UE or may be located on the UE side.

In a possible implementation, the types of the one or more types of PDCCH candidates include a first type PDCCH and scheduling PDCCH.

In a possible implementation, the device further comprises: the candidate listening unit further includes a first candidate listening subunit configured to listen to the first type of PDCCH candidates in accordance with the configured listening timing.

In a possible implementation, the first candidate listening subunit is further configured to, after detecting the initial signal, if the current time slot is not a full time slot, listen to the PDCCH candidates in accordance with the listening timing configuration configured by the RRC in the remaining symbols of the current time slot or in accordance with the listening timing configuration configured by the RRC in subsequent full time slots of the current time slot. Listening to the first type of PDCCH candidates when the listening timing configuration is for the first type of PDCCH candidates.

In a possible implementation, the first candidate listening subunit is further configured to, after detecting the initial signal, listen to the first type of PDCCH candidates in a default manner in the remaining symbols of the current time slot if the current time slot is not a full time slot.

In a possible implementation, the first candidate listening subunit is further configured to listen to the PDCCH candidates in accordance with the listening timing configured by the RRC in the subsequent full time slots of the current time slot. Listening to the first type of PDCCH candidates when the listening timing configuration is for the first type of PDCCH candidates.

In a possible implementation, the first candidate listening subunit is further configured to, after detecting the initial signal, if the current time slot is not a full time slot, listen to the first type of PDCCH candidates in a default manner in the remaining symbols of the current time slot, and listen to the PDCCH candidates in accordance with the listening timing configured by the RRC in the subsequent full time slot of the current time slot. Listening to the first type of PDCCH candidates when the listening timing configuration is for the first type of PDCCH candidates.

In a possible implementation, the first candidate listening subunit is further configured to listen to the PDCCH candidates in accordance with the time slot for forming a part of time slot configured by the RRC in the remaining symbols of the current time slot. Listening to the first type of PDCCH candidates when the listening timing configuration is for the first type of PDCCH candidates.

In a possible implementation, the first candidate listening subunit is further configured to listen to the PDCCH candidates in accordance with the listening timing configured by the RRC in the subsequent full time slot of the current time slot. Listening to the first type of PDCCH candidates when the listening timing configuration is for the first type of PDCCH candidates.

In a possible implementation, the first candidate listening subunit is further configured to, after detecting the initial signal, if the current time slot is not a full time slot, not require to listen to the first type of PDCCH candidates in the current time slot and listen to the PDCCH candidates in accordance with the listening timing configured by the RRC in the subsequent full time slot of the current time slot. Listening to the first type of PDCCH candidates when the listening timing configuration is for the first type of PDCCH candidates.

In a possible implementation, the candidate listening unit further comprises: a second candidate listening subunit configured to listen to the scheduling PDCCH candidates in accordance with the configured listening timing.

In a possible implementation, the second candidate listening subunit is further configured to, if the first type of PDCCH candidates are not detected, listen to the PDCCH candidates in accordance with the listening timing configuration configured by the RRC and listen to the scheduling PDCCH in accordance with the listening timing configuration.

In a possible implementation, the second candidate listening subunit is further configured to be, if the first type of PDCCH candidates are not detected, not required to listen to the scheduling PDCCH until the first type of PDCCH candidates is detected.

In a possible implementation, the device further comprises an index acquisition unit configured to acquire the starting time slot position corresponding to the indication information of the first type of DCI.

In a possible implementation, the index acquisition unit is further configured to take the current time slot (i.e., the time slot where the first type of PDCCH is detected) as the starting time slot corresponding to the indication information of the first type of DCI.

In a possible implementation, the index acquisition unit is further configured to, if the index of the current time slot is n and the current time slot is the kth time slot in the COT structure, take the index of the starting time slot corresponding to the indication information of the first type of DCI as n-k, where k≥0.

In a possible implementation, the index acquisition unit is further configured to, if the index of the current time slot is in a time slot format cycle, take the starting time slot corresponding to the indication information of the first type of DCI as the first time slot in the time slot format cycle, wherein the time slot format cycle is indicated by RRC signaling.

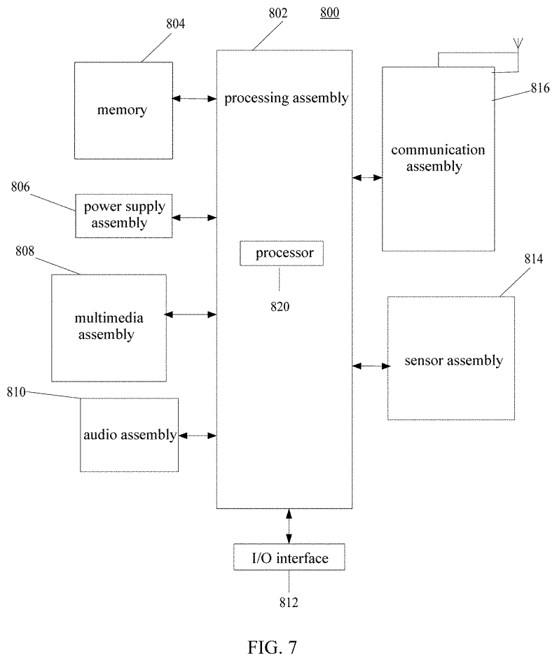

FIG. 7 is a block diagram illustrating an initial signal processing device 800 according to an embodiment of the present disclosure. For example, the initial signal processing device 800 may be a cell phone, a computer, a digital broadcast terminal, a messaging device, a gaming console, a tablet device, a medical device, a fitness device, a personal digital assistant and the like.

Referring to FIG. 7, the initial signal processing device 800 can include one or more of the following assemblies: a processing assembly 802, a memory 804, a power supply assembly 806, a multimedia assembly 808, an audio assembly 810, an input/output (I/O) interface 812, a sensor assembly 814, and a communication assembly 816.

The processing assembly 802 controls the overall operation of the initial signal processing device 800, such as operations associated with display, telephone call, data communication, camera operation, and recording operation. The processing assembly 802 can include one or more processors 820 to execute instructions to complete all or some of the steps of the method described above. In addition, the processing assembly 802 can include one or more modules that facilitate interactions between the processing assembly 802 and other assemblies. For example, the processing assembly 802 can include a multimedia module to facilitate interactions between multimedia assembly 808 and processing assembly 802.

The memory 804 is configured to store various types of data to support operations on the initial signal processing device 800. Examples of such data include instructions for any application or method operating on the initial signal processing device 800, contact data, phonebook data, messages, pictures, videos, etc. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory disk or CD-ROM.

The power supply assembly 806 provides power to the various assemblies of the initial signal processing device 800. The power supply assembly 806 can include a power management system, one or more power supplies, and other assemblies associated with generating, managing, and distributing power for the initial signal processing device 800.

The multimedia assembly 808 includes a screen providing an output interface between the initial signal processing device 800 and a user. In some embodiments, the screen can include a liquid crystal display (LCD) and a touch panel (TP). If the screen includes a touch panel, the screen may be implemented as a touch screen to receive input signals from the user. The touch panel includes one or more touch sensors to sense touching, sliding, and other gestures on the touch panel. The touch sensors may not only sense boundaries of the touching or sliding action but also detect duration and pressure associated with the touching or sliding action. In some embodiments, the multimedia assembly 808 includes a front-facing camera and/or a rear-facing camera. The front camera and/or rear camera may receive external multimedia data when the initial signal processing device 800 is in an operation mode, such as a shooting mode or a video mode. Each front-facing camera and rear-facing camera may be a fixed optical lens system or have focal length and optical zoom capability.

The audio assembly 810 is configured to output and/or input audio signals. For example, the audio assembly 810 includes a microphone (MIC) configured to receive external audio signals when the initial signal processing device 800 is in an operation mode, such as calling mode, recording mode, and voice recognition mode. The received audio signals may be further stored in a memory 804 or transmitted via the communication assembly 816. In some embodiments, the audio assembly 810 further includes a speaker for outputting audio signals.

The I/O interface 812 provides an interface between the processing assembly 802 and a peripheral interface module which may be a keypad, a click wheel, a button, etc. These buttons can include, but are not limited to a home button, a volume button, a start button, and a lock button.

The sensor assembly 814 includes one or more sensors configured to provide status assessment of various aspects of the initial signal processing device 800. For example, the sensor assembly 814 can detect an open/closed state of the initial signal processing device 800, a relative positioning of assemblies such as a display and a keypad of the initial signal processing device 800; the sensor assembly 814 can also detect a change in position of the initial signal processing device 800 or a assembly of the initial signal processing device 800, presence or absence of a contact between the user and the initial signal processing device 800, orientation or acceleration/deceleration of the initial signal processing device 800 and a change in temperature of the initial signal processing device 800. The sensor assembly 814 can include a proximity sensor configured to detect presence of a nearby object in the absence of any physical contact. The sensor assembly 814 can also include a light sensor, such as a CMOS or CCD image sensor to be used in an imaging application. In some embodiments, the sensor assembly 814 can also include an accelerometer sensor, a gyroscope sensor, a magnetic sensor, a pressure sensor, or a temperature sensor.

The communication assembly 816 is configured to facilitate communications between the initial signal processing device 800 and other devices by wired or wireless means. The initial signal processing device 800 can access to a wireless network based on a communication standard, such as WiFi, 2G or 3G, or a combination thereof. In one exemplary embodiment, the communication assembly 816 receives broadcast signals or broadcast-related information from an external broadcast management system via a broadcast channel. In an exemplary embodiment, the communication assembly 816 further comprises a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In exemplary embodiments, the initial signal processing device 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic assemblies for performing the methods described above.

In exemplary embodiments, a computer-readable storage medium, such as a memory 804 including computer program instructions, is also provided, and the computer program instructions can be executed by a processor 820 of the initial signal processing device 800 to accomplish the method described above. The computer-readable storage medium can be a non-volatile computer-readable storage medium or a volatile computer-readable storage medium.

In exemplary embodiments, a computer program is also provided, the computer program comprising computer-readable code, and when the computer-readable code runs in the electronic device, the processor in the electronic device executes any of the method embodiments of the present disclosure.

The present disclosure may be implemented by a system, a method, and/or a computer program product. The computer program product can include a computer-readable storage medium having computer-readable program instructions for causing a processor to carry out the aspects of the present disclosure stored thereon.

The computer-readable storage medium can be a tangible device that can retain and store instructions used by an instruction executing device. The computer-readable storage medium may be, but not limited to, e.g., electronic storage device, magnetic storage device, optical storage device, electromagnetic storage device, semiconductor storage device, or any proper combination thereof. A non-exhaustive list of more specific examples of the computer-readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer-readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer-readable program instructions described herein can be downloaded to individual computing/processing devices from a computer-readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium in the respective computing/processing devices.

Computer-readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the procedural programming languages, such as the “C” programming language or similar programming languages. The computer-readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer-readable program instructions; the electronic circuitry may execute the computer-readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer-readable program instructions.

These computer-readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer-readable program instructions may also be stored in a computer-readable storage medium, wherein the instructions cause a computer, a programmable data processing device and/or other devices to function in a particular manner, such that the computer-readable storage medium having instructions stored therein comprises a product that includes instructions implementing aspects of the functions/acts specified in one or more blocks in the flowchart and/or block diagram.

The computer-readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

Without violating logic, different embodiments of the present disclosure can be combined with each other. The description of different embodiments can be focused, and the part of the description for the focus can be found in other embodiments.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical disclosures of the embodiments and the technical improvements to the arts on market, or to make the embodiments described herein understandable to one skilled in the art.

According to one aspect of the present disclosure, there is provided a device for initial signal processing, the device comprising: a candidate listening unit configured to listen to the one or more types of PDCCH candidates in accordance with a configured listening timing after detecting the initial signal on the unlicensed spectrum.

According to another aspect of the present disclosure, there is provided a computer-readable storage medium on which computer program instructions are stored, wherein the computer program instructions, when executed by a processor, implement any one of the above methods.

According to still another aspect of the present disclosure, there is provided a computer program comprising a computer-readable code, wherein when the computer-readable code runs in an electronic device, the processor in the electronic device executes any one of the above methods described.

1. A method for initial signal processing, wherein the method comprises:
determining, by a UE after detecting an initial signal in an unlicensed spectrum, one or more types of Physical Downlink Control Channel (PDCCH) candidates for which listening is required.

2. The method according to claim 1, wherein the types of the one or more types of PDCCH candidates include a first type PDCCH and scheduling PDCCH.

3. The method according to claim 2, wherein the method further comprises:
indicating, by the UE via the first type of PDCCH candidates, a Channel Occupancy Time (COT) structure.

4. The method according to claim 2, wherein the method further comprises:
obtaining, by the UE via listening to the first type of PDCCH candidates, first type of Downlink Control Information (DCI); and
determining, by the UE via the first type of DCI, the PDCCH candidates for which listening is required.

5. The method according to claim 4, wherein said determining, by the UE via the first type of DCI, the PDCCH candidates for which listening is required comprises:
determining, after detecting the initial signal, the first type of DCI; and
determining the PDCCH candidates for which listening is required, after determining at least one of (a) Control Resource Sets (CORESETs) of all the candidates, (b) search space sets of all the candidates, or (c) Bandwidth Parts (BWPs) of all the candidates based on the first type of DCI.

6-7. (canceled)

8. The method according to claim 2, wherein the determined PDCCH candidates for which listening is required after detecting the initial signal comprises the first type of PDCCH candidates.

9. The method according to claim 8, wherein the method further comprises:
determining, after detecting the initial signal in one or more sub-bands, that frequency domain resources of the PDCCH candidates for which listening is required are in the sub-bands.

10. The method according to claim 9, wherein said determining, after detecting the initial signal in one or more sub-bands, that frequency domain resources of the PDCCH candidates for which listening is required are in the sub-bands further comprises, after detecting the initial signal in the sub-bands by the UE, one of the operations of:
determining by the UE, in a process of determining all candidate PDCCHs, that it is required to listen to a PDCCH candidate based on that the frequency domain resources of the PDCCH candidate is contained in the sub-bands;
determining by the UE, in a process of determining the CORESETs of all the candidates, that it is required to listen to a PDCCH candidate in the CORESETs based on that the CORESETs are contained in the sub-bands; or
determining by the UE, in a process of determining search space sets of all candidates, that it is required to listen to a search space set based on that the CORESETs associated with the search space set is contained in the sub-bands.

11-12. (canceled)

13. The method according to claim 9, wherein said determining, after detecting the initial signal in one or more sub-bands, that frequency domain resources of the PDCCH for which listening is required are in the sub-bands further comprises:
determining BWPs of all the candidates by the UE after detecting the initial signal in the sub-bands;
determining that the BWPs are activated by the UE based on that the BWPs are contained in the sub-bands; and
after determining that the BWPs obtained from inspection are activated, determining by the UE that all the PDCCHs configured in the search space sets in the BWPs are required to be detected.

14. (canceled)

15. The method according to claim 8, wherein the method further comprises:
determining, by the UE after detecting one or more initial signals, that PDCCH candidates associated with the initial signals as PDCCH candidates for which listening is required; and
listening to, by the UE based on a plurality of initial signals, the PDCCH candidates associated with each of the plurality of initial signals in the plurality of initial signals.

16. The method according to claim 15, wherein said determining, by the UE after detecting one or more initial signals, that PDCCH candidates associated with the initial signals as PDCCH candidates for which listening is required further comprises:
listening to, by the UE after detecting the initial signals, PDCCH candidates associated with the initial signals.

17. The method according to claim 15, wherein said determining, by the UE after detecting one or more initial signals, that PDCCH candidates associated with the initial signals as PDCCH candidates for which listening is required further comprises:
determining, by the UE after detecting the initial signal, a CORESET ID associated with the initial signal; and
listening to by the UE only the PDCCH candidates in the associated CORESETs, or only the PDCCH candidates in a search space set associated with the associated CORESET.

18. (canceled)

19. The method according to claim 15, wherein said determining, by the UE after detecting one or more initial signals, that PDCCH candidates associated with the initial signals as PDCCH candidates for which listening is required further comprises:
determining, by the UE after detecting the initial signal, a search space set ID associated with the initial signal; and
listening to, by the UE, only the PDCCH candidates in the associated search space set.

20. The method according to claim 15, wherein said determining, by the UE after detecting one or more initial signals, that PDCCH candidates associated with the initial signals as PDCCH candidates for which listening is required further comprises:
determining, by the UE after detecting the initial signal, a BWP ID associated with the initial signal, the UE being configured to determine that the BWPs are activated; and
listening to, by the UE, only PDCCH candidates configured in the search space sets within the activated BWPs.

21. (canceled)

22. The method according to claim 1, wherein the method further comprises:
obtaining, by the UE, a starting time slot position corresponding to indication information of the first type of DCI.

23. The method according to claim 22, wherein the obtaining, by the UE, the starting time slot position corresponding to the indication information of the first type of DCI further comprises:
taking a current time slot as the starting time slot corresponding to the indication information of the first type of DCI.

24. The method according to claim 22, wherein the obtaining, by the UE, the starting time slot position corresponding to the indication information of the first type of DCI further comprises:
taking the starting time slot position corresponding to the indication information of the first type of DCI as n-k, where the index of the current time slot is n and the current time slot is the kth time slot in a COT structure, where k≥0.

25. The method according to claim 22, wherein the obtaining, by the UE, the starting time slot position corresponding to the indication information of the first type of DCI further comprises:
taking the starting time slot corresponding to the indication information of the first type of DCI as a first time slot in a time slot format cycle, based on that the index of the current time slot is in the time slot format cycle; wherein the time slot format cycle is indicated via RRC signaling.

26-37. (canceled)

38. An initial signal processing device, wherein the device comprises:
a processor; and
a memory configured to store processor-executable instructions, wherein the processor is configured to invoke the instructions to determine, after detecting an initial signal in an unlicensed spectrum, one or more types of Physical Downlink Control Channel (PDCCH) candidates for which listening is required.

39-74. (canceled)

75. A computer-readable storage medium having computer program instructions stored thereon, wherein the computer program instructions, upon being executed by a processor, causes the processor to perform the operation of:
determining, by a UE after detecting an initial signal in an unlicensed spectrum, one or more types of Physical Downlink Control Channel (PDCCH) candidates for which listening is required.

76. (canceled)
